(19) United States
(12) Patent Application Publication
(10) Pub. No.: US 2008/0292078 A1
(43) Pub. Date: Nov. 27, 2008

(54) PHONE NUMBER IDENTIFICATION APPARATUS AND METHOD OF USING THE SAME

(75) Inventor: MU-ANN CHEN, Jen Te (TW)

Correspondence Address: PCE INDUSTRY, INC.;ATT. CHENG-JU CHIANG, 458 E. LAMBERT ROAD, FULLERTON, CA, 92835, US

(73) Assignee: CHI MEI COMMUNICATION SYSTEMS, INC., Jen Te Shiang (TW)

(21) Appl. No.: 11/938,485

(22) Filed: Nov. 12, 2007

(30) Foreign Application Priority Data
May 25, 2007 (CN) 200710074589.X

(51) Int. Cl. H04M 1/56

(52) U.S. Cl. 379/142.06

(57) ABSTRACT

A phone number identification apparatus (100) includes a controlling module (10), a storage module (12), a calculating module (13) and a displaying module (14). The controlling module controls the receiving module, the storage module, the calculating module and the displaying module. The storage module is connected to the controlling module and stores phone numbers and names corresponding to the phone numbers. The calculating module is connected to the storage module and transforms incoming phone numbers and stored phone numbers into codes in the form of numerical values, and compares the codes of the incoming phone numbers and the codes of the stored phone numbers. The displaying module is connected to the controlling module and displays the incoming phone number or the name corresponding to a stored phone number which is identical to the incoming phone number according to the result of comparisons.

### BACKGROUND OF THE INVENTION

1. Field of the Invention

The present invention relates to phone number identification apparatuses and identification methods and, particularly, to a phone number identification apparatus and a phone number identification method simplifying the identification process and increasing identification rate.

2. Description of Related Art

Most mobile phones can identify and display phone numbers of incoming phone calls. Generally, each mobile phone has a storage module which stores a plurality of phone numbers and names corresponding to these numbers. When the mobile phone receives an incoming phone signal, the storage module thereof searches for the incoming phone number in the storage module. The incoming phone number is compared with the stored phone numbers. If the incoming phone number is identical to a stored phone number, the mobile phone can display a name corresponding to the stored phone number (i.e., the incoming phone number) for the user to identify the caller.

A widely used conventional method for identification of incoming phone number is comparing the incoming phone number with the stored phone numbers in sequence. In this method, the incoming phone number and the stored phone numbers are all defaulted to be character strings. Each character of the incoming phone number is compared in sequence with the character in corresponding digit of each stored phone number. If all characters of the incoming phone number are identical to the characters in corresponding digits of a stored phone number, the mobile phone determines that the incoming phone number is identical to the stored number. However, this identification method requires a lot of time and uses a lot of memory of the mobile phone when the number of the stored phone number is large or the stored number has many digits.

Therefore, a new phone number identification apparatus and a new phone number identification method are desired in order to overcome the above-described shortcomings.

### SUMMARY

In one aspect, a phone number identification apparatus includes a storage module, a calculating module and a displaying module. The controlling module controls the receiving module, the storage module, the calculating module and the displaying module. The storage module is connected to the controlling module and stores phone numbers and names corresponding to the phone numbers. The calculating module is connected to the storage module and transforms incoming phone numbers and stored phone numbers into codes in the form of numerical values, and compares the codes of the incoming phone numbers with the codes of the stored phone numbers. The displaying module is connected to the controlling module and displays the incoming phone number or the name corresponding to a stored phone number that is identical to the incoming phone number according to the result of comparisons.

In another aspect, a phone number identification method is provided. Firstly, Phone numbers and names corresponding to the phone numbers are in advance stored. Secondly, an incoming phone signal is received. Thirdly, the incoming phone number and the stored phone numbers are transformed into codes in the form of numerical values. Fourthly, the codes of the incoming phone number are compared with the codes of the stored phone numbers. The incoming phone number or the name corresponding to a stored phone number that is identical to the incoming phone number is displayed according to the result of comparisons using the displaying module.

Other advantages and novel features will become more apparent from the following detailed description when taken in conjunction with the accompanying drawings.

### BRIEF DESCRIPTION OF THE DRAWINGS

Many aspects of the present phone number identification apparatus and method can be better understood with reference to the following drawings. The components in the various drawings are not necessarily drawn to scale, the emphasis instead being placed upon clearly illustrating the principles of the present phone number identification apparatus and method. Moreover, in the drawings, like reference numerals designate corresponding parts throughout the diagrams.

FIG. 1 is a diagram of a phone number identification apparatus, in accordance with a present embodiment;

FIG. 2 is a flow chart of a phone number identification method, in accordance with a present embodiment; and

FIG. 3 is a tabulation of an encoding step of the phone number identification method shown in FIG. 2.

### DETAILED DESCRIPTION OF THE INVENTION

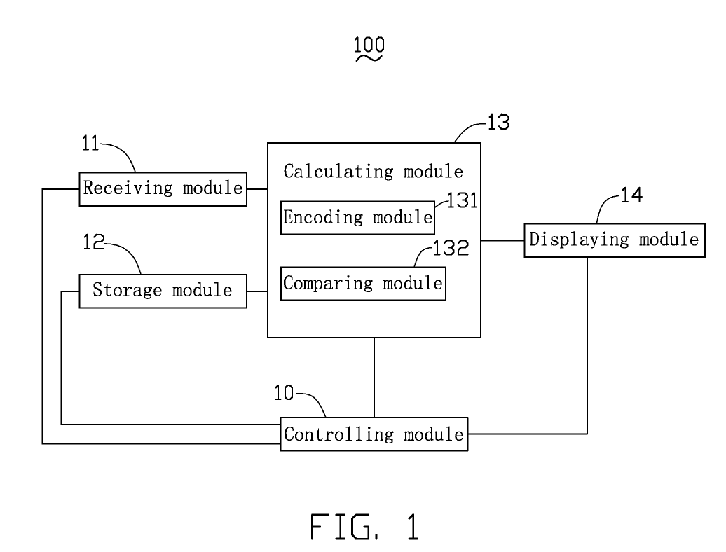

Referring now to the drawings in detail, FIG. 1 shows a phone number identification apparatus 100, in accordance with a present embodiment. The phone number identification apparatus 100 is installed in a typical mobile phone (not shown) and includes a controlling module 10, a receiving module 11, a storage module 12, a calculating module 13 and a displaying module 14. The receiving module 11, the storage module 12, the calculating module 13 and the displaying module 14 are all electronically connected to the controlling module 10. The storage module 12 and the receiving module 11 are electronically connected to the calculating module 13. The calculating module 13 is electronically connected to the displaying module 14.

The controlling module 10 is a microprocessor installed in a typical circuit board of the mobile phone. The controlling module 10 is electronically connected to the receiving module 11, the storage module 12, the calculating module 13 and the displaying module 14. The receiving module 11, the storage module 12, the calculating module 13 and the displaying module 14 are all controlled to work by the controlling module 10.

The receiving module 11 is configured for receiving incoming phone calls. The receiving module 11 can be a typical receiving apparatus, such as an antenna of the mobile phone, and also can be independently installed in the mobile phone.

The storage module 12 is configured for storing phone numbers in the form of character strings and storing caller names corresponding to the phone numbers. The storage module 12 can be a typical storing apparatus, such as a memory of the mobile phone, and also can be independently installed in the mobile phone.

The calculating module 13 is a microprocessor installed in a typical circuit board of the mobile phone. The calculating module 13 includes an encoding module 131 and a comparing module 132. The encoding module 131 transforms the incoming phone numbers and the stored phone numbers from character strings into numerical values. The comparing module 132 compares the incoming phone numbers with the stored phone numbers.

The displaying module 14 is a typical display of the mobile phone. The displaying module 14 can display names corresponding to the stored phone numbers, and also can display incoming phone numbers directly.

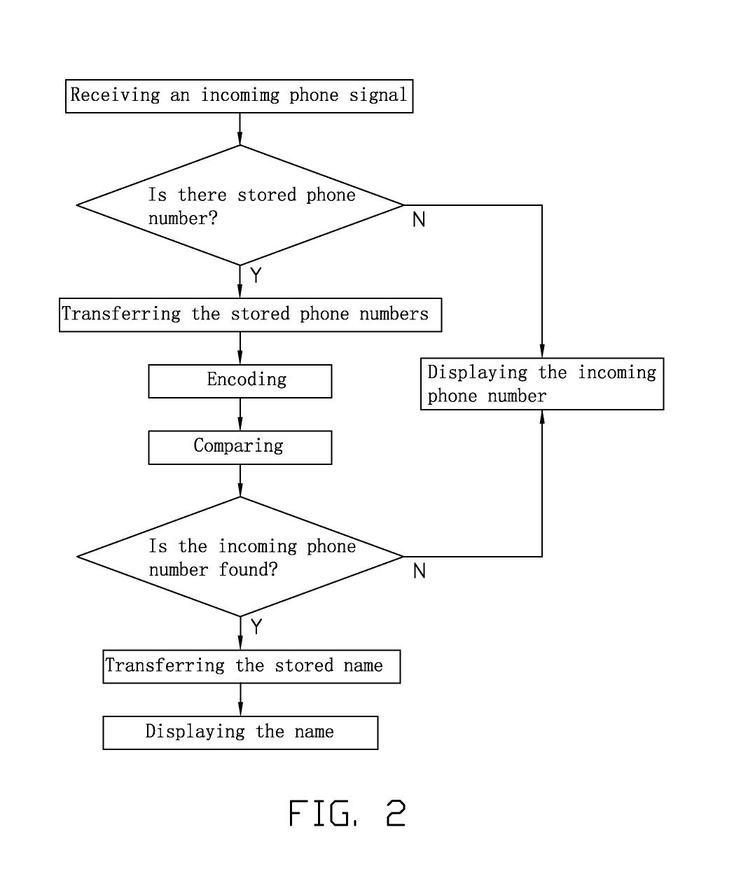

Referring to FIG. 2, a phone number identification method in accordance with a present embodiment is provided. The phone number identification method includes the steps of installing the phone number identification apparatus 100 to identify incoming phone numbers, and displaying the incoming phone numbers properly according to the identification results. The phone number identification method includes these steps as follows.

Provide the phone number identification apparatus 100 as described, and install the phone number identification apparatus 100 in a mobile phone.

Store predetermined phone numbers in the form of character strings and names corresponding to these phone numbers in the storage module 12.

The receiving module 11 receives an incoming phone signal that contains an incoming phone number and transfers the received incoming phone signal to the controlling module 10.

The controlling module 10 searches the stored phone number in the storage module 12 in order to see whether there is one stored phone number identical to the received incoming phone number. The displaying module 14 directly displays the incoming phone number when there is no stored phone number matching the incoming phone number.

The incoming phone number and the stored phone numbers are transferred to the calculating module 13.

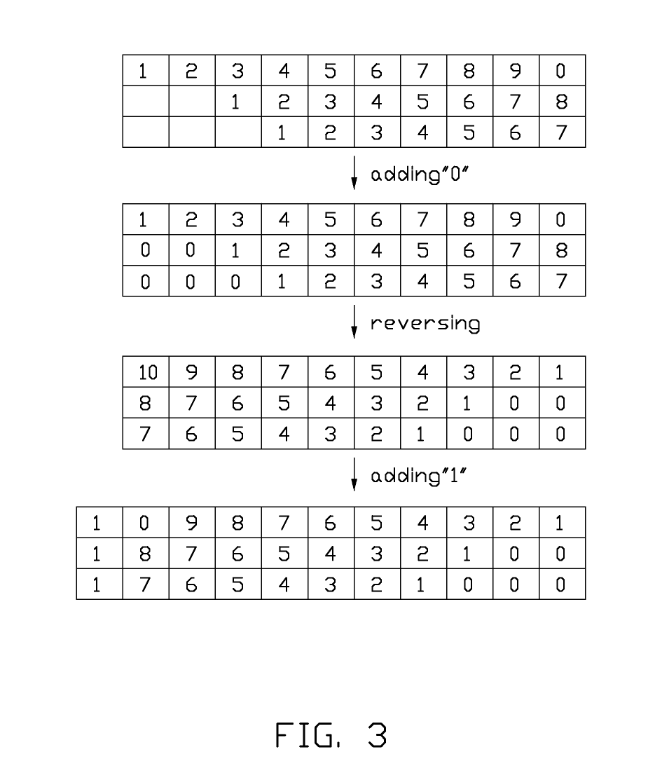

The encoding module 131 encodes the incoming phone numbers and the stored phone numbers. Also referring to FIG. 3, an encoding method that is performed by the encoding module 131 includes a few substeps.

A phone number having most digits in the incoming phone number and the stored phone numbers is chosen to be a norm. Characters “0” are added to the front of each phone number having less digits than the norm until the number of the digits of each phone number is equal to that of the norm, thus ensuring all phone numbers are of identical length. For example, if the phone number having most digits in the incoming phone number and the stored phone numbers is 1234567890, the phone number 12345678 is changed to 0012345678. Identically, the phone number 1234567 is changed to 0001234567.

All phone numbers of identical length are reversed to prevent the added zeros (“0”) from causing possible distortion in later numerical transformation. For example, the phone number 0012345678 is changed to 8765432100. Otherwise, if the phone numbers were not reversed, the phone number 0012345678 might be transformed into 12345678 in the numerical transformation, thus giving the phone numbers different lengths.

A character “1” is added to the front end of each reversed phone number to prevent the characters “0” in the front ends of the reversed phone numbers (i.e., the back end of the initial phone numbers) from causing possible distortion in later numerical transformation. For example, the phone number 8765432100 is changed to 18765432100; the initial phone number 1234567890 (this phone number having most digits and not requiring adding “0” in its front end) is reversed to be 0987654321, and then changed to 10987654321. Otherwise, if the character “1” was not added to the phone numbers, the phone number 0012345678 might be transformed to 12345678 in the later numerical transformation, thus the phone numbers have a different number of digits.

The phone numbers are transformed from strings into codes in the form of numerical values having a same number of digits. The phone numbers are then arranged according to the numerical values of their codes to form a list for comparison.

The code X of the incoming phone number is compared with the codes of the stored phone numbers via the comparing module 132. Since the codes are in the form of numerical values, they can be directly compared with others using mathematical methods. In this embodiment, the comparing module 132 compares the codes using a binary search. In this method, the code X of the incoming phone number is firstly compared with a middle code M of the list for comparison arranged according to the numerical values of the codes of the stored phone numbers. If X=M, the incoming phone number is identical to the stored phone number corresponding to the code M, thus completing comparison. If X<M, the comparing module 132 compares X with the codes that are less than M with the method of binary search; if X>M, the comparing module 132 compares X with the codes that are larger than M with the method of binary search. In this way, comparing once can reduce a half of the list for comparison. Repeat comparing to find out whether the code X is in the list for comparison.

After comparing, the incoming phone number is displayed according to the result of comparison. If the numerical code value A found in the comparison list is equal to that of the code X, the incoming phone number is indicated to be identical to a stored phone number corresponding to the code A. In this case, the controlling module 10 finds the stored phone number corresponding to the code A, and then finds the stored name corresponding to the stored phone number and transfers the stored name to the displaying module 14 to be displayed. If there is no numerical code value equal to that of the code X found in the comparison list, the controlling module 10 transfers the incoming phone number to the displaying module 14 to directly display the incoming phone number.

Understandably, in this identification method, the incoming phone numbers and the stored phone numbers are all encoded in the form of numerical values, thus the codes of the phone numbers can be directly compared with others. Compared to the typical method of comparing the characters of the incoming phone number in sequence with the characters in corresponding digits of all stored phone numbers, the identification method of the present embodiment can decrease identification time and use mathematical methods to improve the identification rate.

For further improving the identification rate, when the storage module 12 stores new phone numbers, the controlling module 10 can instruct the calculating module 13 to encode the phone numbers in numerical values and transfer the codes of the phone numbers to the storage module 12 to store. In this way, when the mobile phone receives an incoming phone signal, the calculating module 13 does not need to temporarily code the stored phone numbers. Only the incoming phone number needs to be coded and compared with the stored codes of the stored phone numbers.

Furthermore, the controlling module 10 can sample some characters in specific digits of each phone number (i.e., the incoming phone number and the stored phone numbers) and encode the characters of each phone number as short character strings corresponding to the phone numbers in inquiry. Thus, the controlling module 10 instructs the calculating module 13 to encode the strings in the aforementioned method and compare the codes of the strings with others. However, if the sampled characters of a phone number are all identical to that in corresponding digits of another phone number, the two phone numbers are compared with each other using the typical method of comparing the characters of the incoming phone number with the characters in their corresponding digits. Therefore, this sampling method is quicker as there will be fewer phone numbers having identical characters in digits sampled.

Understandably, the phone number identification apparatus 100 storing no phone numbers and names can also be used to receive incoming phone signals, and directly displays each incoming phone number via the displaying module 14 without the steps of encoding and comparing.

Additionally, the phone number identification apparatus 100 can also be installed in base stations of wireless communication nets. In this way, the controlling module 10, the storage module 12 and the calculating module 13 can all be replaced by computers, thus the identification rate can be greatly improved.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A phone number identification apparatus, comprising:
a controlling module;
a storage module connected to the controlling module and controlled by the controlling module, the storage module storing phone numbers and names corresponding to the phone numbers;
a calculating module connected to the storage module and controlled by the controlling module, the calculating module transforming incoming phone numbers and stored phone numbers into codes in the form of numerical values, and comparing the codes of the incoming phone numbers and the codes of the stored phone numbers; and
a displaying module connected to the controlling module and controlled by the controlling module, the displaying module displaying the incoming phone number or the name corresponding to a stored phone number which is identical to the incoming phone number according to the result of comparisons.

2. The phone number identification apparatus as claimed in claim 1, further comprising a receiving module connected to the controlling module for receiving incoming phone signals.

3. The phone number identification apparatus as claimed in claim 1, wherein the calculating module includes an encoding module, the encoding module transforms incoming phone numbers and stored phone numbers from character strings into codes in the form of numerical values.

4. The phone number identification apparatus as claimed in claim 1, wherein the calculating module includes a comparing module which compares the codes of the incoming phone numbers with the codes of the stored phone numbers.

5. The phone number identification apparatus as claimed in claim 4, wherein the comparing module compares the codes of the incoming phone numbers with the codes of the stored phone numbers via a binary search.

6. The phone number identification apparatus as claimed in claim 1, wherein the displaying module displays the stored name corresponding to the stored phone number that is found to be identical to the incoming phone number, and directly displays the incoming phone number when there is no stored phone number found to be identical to the incoming phone number.

7. A phone number identification method, comprising these steps of:
storing phone numbers and names corresponding to the phone numbers;
receiving an incoming phone signal containing an incoming phone number;
transforming the incoming phone number and the stored phone numbers into codes in the form of numerical values.
comparing the codes of the incoming phone number with the codes of the stored phone numbers; and
displaying the incoming phone number or the name corresponding to a stored phone number which is identical to the incoming phone number according to the result of comparison.

8. The phone number identification method as claimed in claim 7, wherein the step of transforming the incoming phone number and the stored phone numbers into codes in the form of numerical values comprising these substeps:
inputting the incoming phone number and the stored phone numbers in the mode of character strings;
choosing a phone number having most digits in the incoming phone number and the stored phone numbers to be a norm, and adding “0” to the front of each phone number having less digits than the norm until the number of the digits of each phone number is equal to that of the norm;
reversing all phone numbers;
adding a “1” to the front end of each reversed phone number; and
transforming the phone numbers from character strings into codes in the form of numerical values.

9. The phone number identification method as claimed in claim 7, wherein the step of transforming the incoming phone number and the stored phone numbers into codes in the form of numerical values comprises:
sampling some characters in specific digits of the incoming phone number and the stored phone numbers and transforming the characters of each phone number into character strings corresponding to the phone numbers;
inputting the character strings corresponding to the incoming phone number and the stored phone numbers;
adding “0” to the front of each character strings;
reversing all character strings;
adding a character “1” to the front end of each reversed character strings; and
transforming the character strings into codes in the form of numerical values.

10. The phone number identification method as claimed in claim 7, further comprising the step of comparing the codes of the incoming phone number and the codes of the stored phone numbers in the method of binary search.

11. The phone number identification method as claimed in claim 7, further comprising the step of directly displaying the incoming phone number when no corresponding phone number and name is stored in the storage module.

12. The phone number identification method as claimed in claim 7, wherein a stored name is displayed when the stored phone number corresponding to the stored name is found to be identical to the incoming phone number, and the incoming phone number is directly displayed when no stored phone number is found to be identical to the incoming phone number.
